(19) United States
(12) Patent Application Publication
(10) Pub. No.: US 2011/0000436 A1
(43) Pub. Date: Jan. 6, 2011

(54) FOAM FILTER FOR AQUARIUM HAVING FUNCTION OF PURIFYING AIR AND WATER

(75) Inventors: Bong-Sun Jang, Seoul (KR); Jae Kyun Kim, Daegu (KR)

Correspondence Address: EDWARDS ANGELL PALMER & DODGE LLP, P.O. BOX 55874, BOSTON, MA, 02205, US

(73) Assignee: SHARON KOREA ITEM COMPANY LIMITED, Seoul (KR)

(21) Appl. No.: 11/815,467

(22) PCT Filed: Feb. 6, 2006
(86) PCT No.: PCT/KR2006/000430

§ 371 Date: Sep. 22, 2010

(30) Foreign Application Priority Data
Feb. 5, 2005 (KR) 10-2005-0011060
Feb. 6, 2006 (KR) 10-2006-0011224

(51) Int. Cl. A01K 63/04

(52) U.S. Cl. 119/253; 119/259

(57) ABSTRACT

A foam filter for an aquarium having a function for purifying water and air which is capable of facilitating a replacement and maintenance of components due to an abnormality of a filtering device and an execution of a washing operation (including water refill) of the aquarium by making it convenient to be manufactured and installed depending on a simplified construction of a product which can be selectively disassembled or assembled, and also capable of satisfying user's visual curiosity by improving an externality of the aquarium, wherein the foam filter for the aquarium having the function for purifying water and air can be achieved by being provided with an installation case provided with a pair of container installation holes which are symmetrical to each other at left and right lateral surfaces based upon a filter installation hole, and having a fluid inlet which is formed through the filter installation hole at central front portion of a bottom surface of the installation case, a multi-layer filter slidingly received in the filter installation hole, a filtering agent container slidingly received in the pair of container installation holes, a filtering case connected to a front portion of the fluid inlet to thus be mounted thereto, and a water screen generator 5 mounted to one lateral surface of the installation case, wherein multiple minute foam generating holes for supplying minute foam into the installation case is further provided.

### TECHNICAL FIELD

The present invention relates to a filtering device applied to an aquarium, and more particularly, to a foam filter for an aquarium having a function for purifying air and water which is capable of effectively removing contaminated materials from the aquarium by increasing an amount of dissolved oxygen by foam which is forcibly provided, and also of maintaining an indoor environment to be clean and delightful by a purified air discharged from the aquarium.

### BACKGROUND ART

Typically, an aquarium refers to a type of an ornamental container which is fabricated for keeping fresh-water aquatic organisms or aquatics from the sea to thus view and research them. The aquarium is usually used to decorate indoor areas such as home, offices, and other public places and also used to adjust indoor humidity in winter.

Regarding a typical construction of an aquarium, first, a water bath filled with a certain amount of water is provided and decorated with sand, gravel, and various underwater ornaments therein. Various aquatics (e.g., fish, or the like) are inputted into the decorated water bath, and an oxygen supply device is selectively added into the water bath in which the aquatics are inputted.

However, in the aquarium having such construction, after a certain time elapses, water filled in the water bath may easily be contaminated by eutrophication caused by evacuation from the aquatic organisms, residual feed supplied, moss growth, and the like.

Accordingly, a user has to refill the water bath with clean water and wash the water bath, which makes the user inconvenient and vexatious.

In addition, the user may use a decontaminant which is diluted and added in the water for dissolving and removing contaminated materials, whenever required, to thus delay the water contamination in the water bath. The decontaminant is a chemical which is artificially manufactured to thus have a bad influence upon an ecologic environment of the aquatic organisms. Particularly, the decontaminant is an expendable material and its effect can not be continued. An unnecessary cost may thusly be uneconomically consumed accordingly to use the decontaminant.

In recent times, on the other side, in order to solve the problem in managing the aquarium, various filtering devices for aquarium have been developed and used so as to naturally filter (purify) the water in the water bath by increasing a dissolved oxygen amount by generating a large amount of minute foam.

However, the various filtering devices developed to apply to the aquarium basically use a foam generator and a filter based purifying unit, and other additional functional components are complicatedly combined therewith.

Thus, the pre-developed filtering devices for the aquarium have such complicated constructions, and are difficult to be manufactured and installed. Also, the complicated structure of the aquarium with the filtering device may degrade an externality of the aquarium.

Meanwhile, the filtering device applied to the aquarium simply purifies the water within the aquarium to thus considerably extend a time at which the aquarium is to be filled with clean water and to be washed. The filtering device must also be inspected and a period for replacing a filter therein must be checked based upon an appropriate time period. Furthermore, the washing and water-replacing operations must be done after the extended time. However, the pre-developed filtering devices for the aquarium are difficult to be selectively disassembled or assembled, and thus it is also difficult to replace and maintain components due to abnormality of the filtering device. Accordingly, unexpected problems in managing it such as difficulty in refilling clean water and washing the aquarium may still remain.

### DISCLOSURE OF INVENTION

### Technical Problem

Therefore, in order to solve the above problems in the related art filtering devices applied to the aquarium, an object of the present invention is to provide a foam filter for an aquarium having a function for purifying water and air which is capable of facilitating a replacement and maintenance of components due to an abnormality of a filtering device and an execution of a washing operation (including a water refill) of the aquarium by making it convenient to be manufactured and installed depending on a simplified construction of a product which can be selectively disassembled or assembled, and also capable of satisfying user's visual curiosity by improving an externality of the aquarium.

According to another object of the present invention is to provide a foam filter for an aquarium having a function for purifying water and air which is capable of effectively dissolving and removing contaminated materials within a water bath by increasing a dissolved oxygen amount due to minute foam forcibly supplied, and also of maintaining clean and pure indoor environment by purified air discharged from the water bath.

### Technical Solution

To achieve the above object, there is provided a foam filter for an aquarium having a function for purifying water and air comprising:

an installation case provided with a pair of container installation holes which are symmetrical to each other at left and right lateral surfaces based upon a filter installation hole, and having a fluid inlet which is formed through the filter installation hole at central front portion of a bottom surface of the installation case, a multi-layer filter slidingly received in the filter installation hole, a filtering agent containers slidingly received in the pair of container installation holes, respectively, a filtering case connected to a front portion of the fluid inlet to thus be mounted thereto, and a water screen generator 5 mounted to one lateral surface of the installation case, wherein multiple minute foam generating holes for supplying minute foam into the installation case is further provided.

### Advantageous Effects

As mentioned above, in the foam filter for the aquarium having the function for purifying water and air according to the present invention, owing to a construction of a product which can selectively be disassembled or assembled, it is possible to facilitate a replacement and maintenance of components when occurs an abnormality in a filtering device applied to the aquarium by being conveniently manufactured and installed, and also possible to satisfy a user's visual curiosity by improving an externality of the aquarium using a beautiful and clean installation structure.

In addition, by using the foam filter for the aquarium having the function for purifying water and air, contaminated materials within a water bath can effectively be and removed in a manner of increasing a dissolved oxygen amount by minute foam forcibly supplied, and a clean and pure indoor environment can be maintained by purified air discharged from the water bath, thereby providing an expected effect to users.

### BRIEF DESCRIPTION OF THE DRAWINGS

FIG. 1 is a perspective view showing an installed state of a foam filter for an aquarium having a function for purifying air and water in accordance with the present invention;

FIG. 2 is an exploded perspective view showing a foam filter for an aquarium having a function for purifying air and water in accordance with the present invention;

FIG. 3 is a lateral sectional view showing that a foam filter for an aquarium having a function for purifying air and water is installed in accordance with the present invention;

FIG. 4 is a front sectional view showing a construction of a foam filter for an aquarium having a function for purifying air and water in accordance with the present invention;

FIG. 5 is an enlarged view showing a minute foam generating hole and a foam generator which are applied to the present invention; and

FIG. 6 is a view showing another embodiment of a foam filter for an aquarium having a function for purifying air and water in accordance with the present invention.

### EXPLANATION FOR THE MAJOR REFERENCE NUMERALS

1: installation case
2: multi-layer filter
3: filtering agent container
4: filtering case
5: water screen generator
6: multiple minute foam generating hole
7: air supply tube
8: foam generator
11: filter installation hole
12: container installation hole
13: opening
14: fluid inlet
15: decorating panel
21,32: blocking layer
22: vertical support plate
23: horizontal plate
31: main receiving space
41: water flow hole
42: mesh net
51: suction tube
52: underwater motor
53: fluid supply tube
61: first foam distributing tube
62: second foam distributing tube
63: third foam distributing tube
100: aquarium

### BEST MODE FOR CARRYING OUT THE INVENTION

Hereinafter, explanation will now be given for preferred embodiments of a foam filter for an aquarium having a function for purifying air and water with reference to the attached drawings.

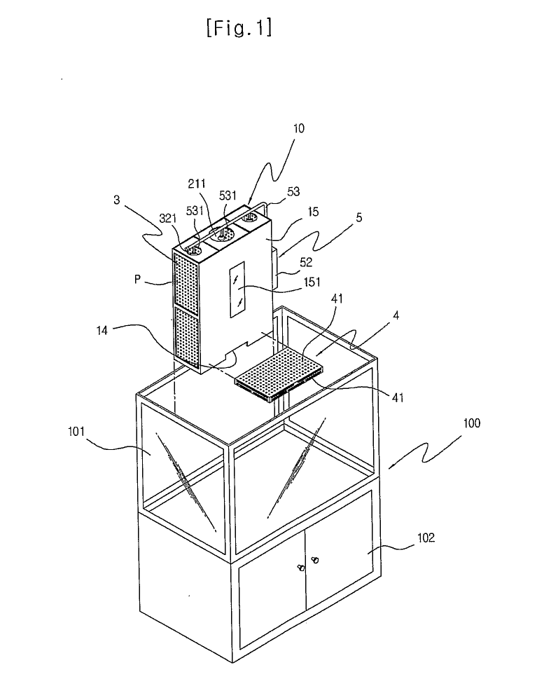

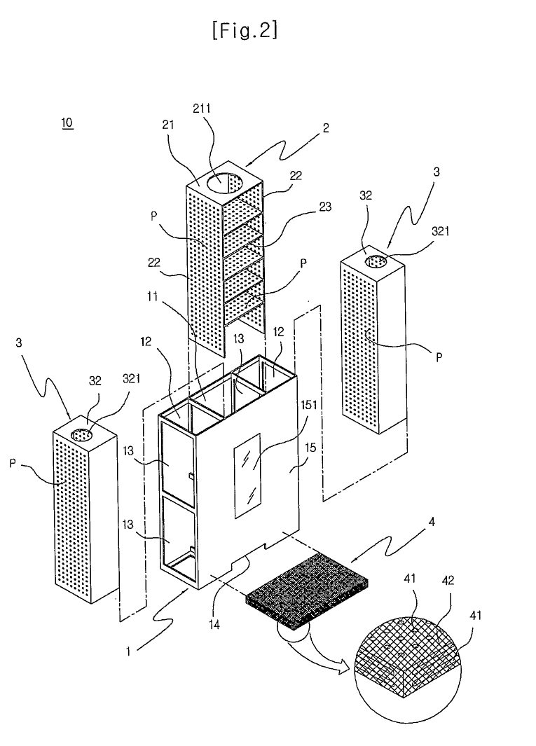

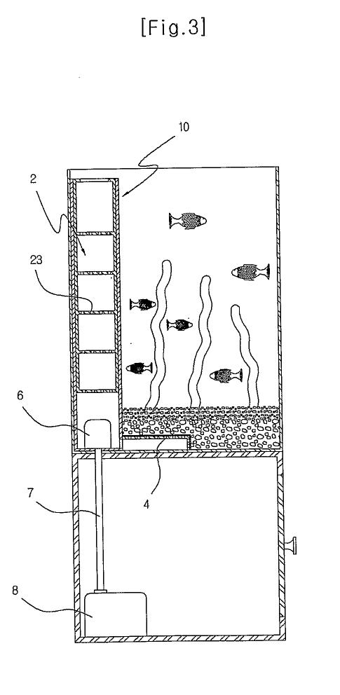

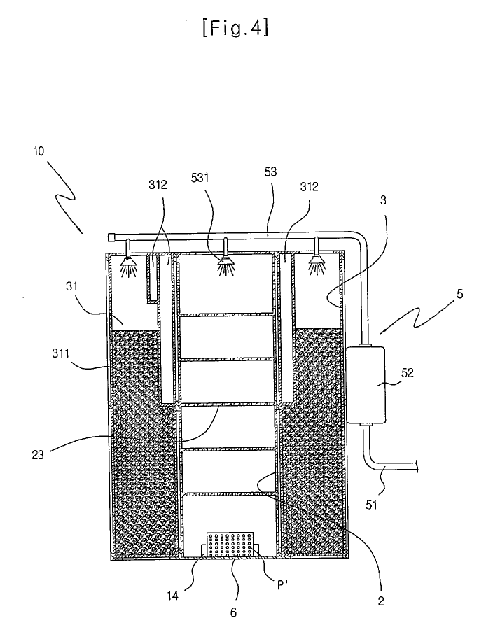

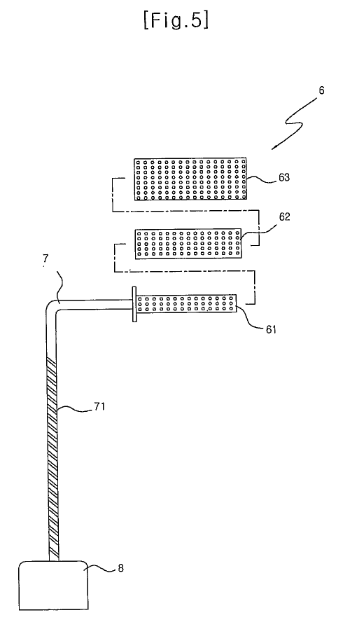

FIG. 1 is a perspective view showing an installed state of a foam filter for an aquarium having a function for purifying air and water in accordance with the present invention, FIG. 2 is an exploded perspective view showing a foam filter for an aquarium having a function for purifying air and water in accordance with the present invention, FIG. 3 is a lateral sectional view showing that a foam filter for an aquarium having a function for purifying air and water is installed in accordance with the present invention, FIG. 4 is a front sectional view showing a construction of a foam filter for an aquarium having a function for purifying air and water in accordance with the present invention, and FIG. 5 is an enlarged view showing a minute foam generating hole and a foam generator which are applied to the present invention.

Referring to FIGS. 1 through 5, a series of constructions have a structure installed in a typical aquarium 100 which includes an installation space 1, a multi-layer filter 2, filtering agent containers 3, a filtering case 4, a water screen generator 5, and a foam filter 10 having a multiple minute foam generating hole 6.

First, the aquarium 100 refers to an ornamental container manufactured in order to raise aquatic organisms (e.g., fish, etc.) for viewing and researching their living environment. The aquarium 100, as shown in FIG. 1, is constituted with a water bath 101 filled with a certain amount of water and a recipiency support 102 for fixing and supporting the water bath 101.

The installation case 1 constructing the foam filter 10 forms an external structure of the present invention. Preferably, as shown in FIG. 1 or 2, a pair of container installation holes 12 which are symmetrical to each other are formed at both left and right lateral surfaces based upon a filter installation hole 11 with a certain length, the filter installation hole 11 being formed in a manner of a vertically penetrating structure. Laterally connected portions between the filter installation hole 11 and the pair of container installation holes 12 disposed within the installation case 1 are penetrated through opened holes 13 which are divided into plurality to thus be connected to each other. Also, a fluid inlet 14 with a rectangular penetrating structure which is connected to the filter installation hole 11 is formed at a central front portion of a bottom surface of the installation case 1.

Here, a front surface of the installation case 1 is covered by using a decoration panel 15 with a rectangular plate shape. The decoration panel 15 having a transparent identification window 151 with a certain area is disposed at a central surface of the decoration panel 15, and the entire surface of the decoration panel 15 except for the identification window 151 is printed with a decorative pattern (not shown).

In addition, preferably, as shown in FIG. 2, an upper surface is formed using a blocking layer 21 having an air discharge hole 211, a pair of vertical support plates 22 which face each other by being spaced from each other with a certain interval are integrally formed at both left and right lateral surfaces of the blocking layer 21, and then a plurality of horizontal plates 23 are regularly and repeatedly disposed at inner lateral surfaces of the pair of vertical support plates 22 in a manner of a multilayered structure, to thus achieve the multi-layer filter 2 constructing the foam filter 2 in a vertically trapeziform shape.

Here, the multi-layer filter 2 formed with the vertical support plate 22 and the horizontal plates 23, as shown in FIG. 2, has a plurality of foam dispersion induction openings P over the entire surface thereof, to thus obtain a net-like structure.

Also, the filtering agent containers 3 constructing the foam filter 10 are formed in a structure of a rectangular case with a certain length, wherein the plurality of foam dispersion openings P are formed at both left and right lateral surfaces and bottom surface of each filtering agent container 3. Preferably, as shown in FIG. 2 or 4, the filtering agent container 3 is constructed by forming a main receiving space 31 filled with the filtering agent 311 therein, forming a blocking layer 32 having an air discharge hole 311 at an upper surface of the main receiving space 31, and having an auxiliary installation receiving portion 312 which is divided into plurality at one surface of an inner side of the main installation receiving space 31.

Here, the filtering agent 311 contained in the main receiving space 31 is a material which is one of active carbon, ceramics, magnet, sand or sponge each of which has a small particle structure. Such material is selectively contained in the main receiving space 31 individually or in plurality. The auxiliary installation receiving portion 312 selectively receives therein typically functional constructions, namely, far-infrared germicidal lamp, optical catalysts, aroma member, and the like (not shown).

The filtering case 4 constructing foam filter 10, as shown in FIG. 2, is formed in a rectangular shape having a plurality of water flow holes 41 to thusly be preferably received in a mesh net 42 as shown in an enlarged view of FIG. 2.

The water screen generator 5 constructing the foam filter 10 includes a underwater motor 52 connected with a suction tube 51. A fluid supply tube 53, as shown in FIG. 1 or 4, is formed at an upper surface of the underwater motor 52 and extends upwardly with a certain length from the upper surface of the underwater motor 52 to be then curved orthogonally. A plurality of scattering nozzles 531 with a uniform interval from one another are disposed on the fluid supply tube 53.

The multiple minute foam generating hole 6 is connected to a typical foam generator 8 via an air supply tube 7 with a certain length to thus be provided with air from the connected foam generator 8. The multiple foam generating hole 6, as shown in FIG. 5, is provided with a first foam distributing tube 61, a second foam distributing tube 62 and a third foam distributing tube 63, each of which has a different diameter and is provided with foam distributing openings P formed through. The first, second and third foam distributing tubes 61, 62 and 63 are sequentially received step by step. Namely, the first foam distributing tube 61 is received in an inner surface of the second foam distributing tube 62, and the second distributing tube 62 in which the first foam distributing tube 61 is received is disposed within an inner surface of the third foam distributing tube 63.

Here, an electro-thermal wire 71 is wound on an outer circumferential surface of the air supply tube 7 which connects the multiple minute foam generating hole 6 with the foam generator 8. The heating operation of the electro-thermal wire 71 is controlled by being selectively connected with an external power source which operates the foam generator 8.

Hence, a brief explanation can be given for the inter-connection of the components constructing the foam filter for the aquarium having the function for purifying water and air according to the present invention having such construction, hereafter.

First, the installation case 1 having the filter installation hole 11, the pair of container installation holes 12, and the fluid inlet 14 is provided.

The multi-layer filter 2, as shown in FIG. 2 or 4, is coupled to the filter installation hole 11 by being slidingly received therein.

The filtering agent containers 3 are slidingly received in the pair of container installation holes 12, respectively.

The filtering case 4 is mounted in the front portion of the fluid inlet 14.

The water screen generator 5 is mounted at one lateral surface of the installation case 1.

Thereafter, finally, the multiple minute foam generating hole 6, as shown in FIG. 3 or 4, is mounted in the bottom surface of the inner center of the installation case 1 to which the multi-layer filter 2 is coupled. According to these connections, the foam filter for the aquarium having the function for purifying water and air can be implemented.

The foam filter for the aquarium having the function for purifying water and air according to the present invention having the aforementioned coupled structure is installed in the typical aquarium as shown in FIG. 1 for use. Accordingly, usage relation and interaction among the components of the foam filter will now be explained hereafter.

First, in a state of providing the aquarium 100 with the foam filter for the aquarium having the function for purifying water and air according to the present invention, upon operating the foam generator 8 by connecting it to the external power source, air is generated according to the operation. The generated air is supplied to the multiple minute foam generating hole 6 via the air supply tube 7.

Here, preferably, a high capacity foam generator which can discharge air of more than 2500 cc per minute can be used as the foam generator 8 applied to the present invention.

The multiple minute foam generating hole 6 interferes in the air of more than 2500 cc discharged through the foam scattering openings P of the first, second and third foam distributing tubes 61, 62 and 63 which are sequentially received in one another, to thus scatter minute foam into the water bath 101. The large amount of the scattered minute foam are then supplied to the multiplayer filter 2.

Accordingly, the minute foam supplied to the multi-layer filter 2 is interrupted step by step by the horizontal plates 23 which are arranged in the multi-layered structure to thus remain in the water with longer delay, thereby increasing the dissolved oxygen amount within the water bath 101. Accordingly, the contaminated materials contained in the water bath 101 are primarily purified (filtered) by an oxidation of the increased dissolved oxygen. The minute foam by which the primary purification has performed passes through the foam dispersion induction openings P formed in the multi-layer filter 2 and the filtering agent containers 3 according to the discharged pressure thereof, to thus be induced back into the filtering agent containers 3, thereby performing a secondary purification by filtering the contaminated materials by the filtering agent 311 filled in the filtering agent containers 3.

The minute foam by which the secondary purification has been performed is discharged out of the foam filter 10, namely, to the indoor area where the aquarium 100 is placed through the air discharge holes 211 and 311 formed at the upper surfaces of the multi-layer filter 2 and the filtering agent containers 3, respectively. Here, it is obvious for the discharged air (i.e., the minute foam) to partially contain toxic gases (e.g., ammonia, etc.) according to the purification operations within the water bath 101. Accordingly, the water screen generator 5, as shown in FIG. 4, sucks water within the water bath 101 by operating the underwater motor 52, and then sprays the sucked water to the air discharge holes 211 and 311 formed in each of the multi-layer filter 2 and the filtering agent containers 3 through a plurality of dispersing nozzles 531, to thus form water screens. Then, the toxic gases contained in the discharged air are completely removed and purified, to thus enable a supply of the purified air in the indoor area.

Here, regarding such usage relation as aforementioned, the minute foam generated through the multiple minute foam generating hole 6 is vertically risen by a constant discharge pressure, and a water pressure is changed at a portion from which the minute foam is discharged. Accordingly, the water within the water bath 101 is forcibly sucked into the foam filter 10 via the fluid inlet 14 according to the water pressure change and then rotated therein, to thus achieve a smooth purification operation.

In addition, regarding such usage relation as aforementioned, when the water within the water bath 101 is forcibly sucked into the foam filter 10 via the fluid inlet 14, the filtering case 4 filters sand, gravel or other foreign materials provided at the bottom surface of the water bath 101 by use of the water flow holes 41 and the mesh net 42 to thus prevent the sand, gravel or other foreign materials from being introduced into the foam filter 10.

Also, regarding such usage relation as aforementioned, the air supply tube 7 on which the electro-thermal wire 71 is wound rises a temperature of the air supplied by the heating operation of the electro-thermal wire 71 to thus maintain an appropriate temperature at which microbe for purification can well live. Hence, even in winter when the temperature is relatively low, the purification can be smoothly performed regardless of seasons.

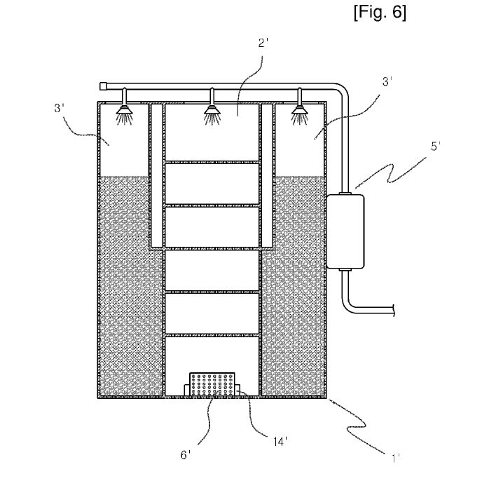

FIG. 6, on the other hand, shows another embodiment of a foam filter for an an aquarium having a function for purifying water and air.

As shown in FIG. 6, an installation case 1 is provided such that a pair of filtering agent filling portions 3 symmetrical to each other are integrally formed at both left and right lateral surfaces based upon a multi-layer filter portion 2, and a fluid inlet 14 which is protrudingly connected to the multi-layer filter portion 2 is formed at a central front portion of a bottom surface of the installation case 1,

A filtering case (not shown) is received in a front portion of the fluid inlet 14, and thereafter a water screen generator 5 is mounted to one lateral surface of the installation case 1, Then, a multiple minute foam generating hole 6 for supplying the minute foam is further provided in the installation case 1, Such construction is achieved such that the entire construction of the foam filter 10 is simply designed as a single integrated body by simplifying the construction shown in the aforementioned one embodiment, which may can come within the scope of the present invention.

Additionally, the foam filter for the aquarium having the function for purifying water and air can purify contaminated water and air by an effective control using the minute foam. Accordingly, the foam filter for the aquarium having the function for purifying water and air can be applied not only to the aquarium but also to wastewater filtering devices or air purifiers for purifying indoor air, which may thusly come with the scope of the present invention.

1. A foam filter for an aquarium having a function for purifying water and air comprising:
an installation case (1) in which a pair of container installation holes (12) which are symmetrical to each other are formed at both left and right lateral surfaces with respect to a filter installation hole (11), and a fluid inlet (14) protrudingly connected to the filter installation hole (11) is formed at a central front portion of a bottom surface of the installation case (1);
a multi-layer filter (2) slidably received in the filter installation hole (11);
filtering agent containers (3) slidably received in the pair of container installation holes (12), respectively;
a filtering case (4) received in the front portion of the fluid inlet (14) for connection therebetween; and
a water screen generator (5) mounted to one lateral surface of the installation case (1),
wherein a multiple minute foam generating hole (6) for supplying the minute foam is further provided within the installation case (1).

2. The foam filter of claim 1, wherein the installation case (1) provided with a transparent identification window (151) and a decoration panel (15) printed with a decorative pattern so as to form a front appearance thereof, and laterally connected portions between the filter installation hole (11) and the pair of container installation holes (12) disposed within the installation case (1) are penetrated through opened holes (13) which are divided into plurality so as to be connected to each other.

3. The foam filter of claim 1, wherein the multi-layer filter (2) is provided with a blocking layer (21) having an air discharge hole (211) disposed at an upper surface thereof, and a pair of vertical support plates (22) which face each other by being spaced from each other and formed at left and right lateral surfaces of the blocking layer (21),
wherein inner lateral surfaces of the pair of vertical support 22 plates (22) are multilayered by a plurality of horizontal plates (23), and
wherein a plurality of foam dispersion induction openings (P) are formed at entire surfaces of the vertical support plate (22) and the plurality of horizontal plates (23).

4. The foam filter of claim 1, wherein the filtering agent container (3) which has a rectangular case structure with a certain length in which the plurality of foam dispersion induction openings (P) are formed, includes
a main receiving space (31) containing a filtering agent 311 therein;
a blocking layer (32) having an air discharge hole (321) formed at an upper surface of the main receiving space (31); and
an auxiliary installation receiving portion (312), which is divided into plurality, provided at an inner lateral surface of the main receiving space (31).

5. The foam filter of claim 1, wherein the filtering case (4) is formed in a rectangular case structure and has a plurality of water flow holes (41), and a mesh net (42) covers an entire outside of the filtering case (4).

6. The foam filter of claim 1, wherein the water screen generator (5) includes an underwater motor (52) to which a suction tube (51) is connected, and wherein a fluid supply tube (53) having a plurality of scattering nozzles (531) is connected to an upper surface of the underwater motor (52), the fluid supply tube (53) extending upwardly with a certain length from the upper surface of the underwater motor (52) to be then curved orthogonally.

7. The foam filter of claim 1, wherein the multiple minute foam generating hole (6) is divided into a first foam distributing tube (61), a second foam distributing tube (62) and a third foam distributing tube (63) which are sequentially coupled by being received in one another step by step, and wherein an air supply tube (7) is connected to one lateral surface of the first foam distributing tube (61) to thus received air supplied from the foam generator (8).

8. The foam filter of claim 1, wherein the main receiving space (31) of the filtering agent container (3) is filled with a material selected from the group consisting of active carbon, ceramics, magnet, sand and sponge each of which has a small particle structure.

9. The foam filter of claim 7, wherein an outer circumferential surface of the air supply tube (7) connected to the first foam distributing tube (61) is wound with an electro-thermal wire (71), and wherein a heating operation of the electro-thermal wire (71) raises the temperature of air.

10. A foam filter for an aquarium having a function for purifying water and air comprising:
an installation case (1) provided with a pair of filtering agent filling portions (3) integrally formed to be symmetrical to each other at both left and right lateral surfaces with respect to a multi-layer filter portion (2); and a fluid inlet (14) penetratingly connected to the multi-layer filter portion (2) at a central front portion of a bottom surface of the installation case (1);
a filtering case received within a front portion of the fluid inlet (14); and
a water screen generator (5) mounted to one lateral surface of the installation case (1); and
wherein a multiple minute foam generating hole (6) further provided within the installation case (1) for supplying minute foam.

11. The foam filter of claim 4, wherein the main receiving space (31) of the filtering agent container (3) is filled with a material selected from the group consisting of active carbon, ceramics, magnet, sand and sponge each of which has a small particle structure.
